(19) United States
(12) Patent Application Publication
(10) Pub. No.: US 2009/0025567 A1
(43) Pub. Date: Jan. 29, 2009

(54) Folding leg system for a cooking appliance

(76) Inventors: Joshua Greenberg, Pittsburgh, PA (US); Nicholas Seager, Delray Beach, FL (US); Anatoly Ratsimor, Brighton, MA (US)

Correspondence Address: Charles R. Ducker, Jr.;Sunbeam Products, Inc., 2381 Executive Center Drive, Boca Raton, FL, 33431, US

(21) Appl. No.: 11/880,719

(22) Filed: Jul. 24, 2007

(51) Int. Cl. A47J 27/08

(52) U.S. Cl. 99/337

(57) ABSTRACT

A cooking appliance having a removable storable lid and having legs which are foldable into at least two positions, one position being an operable position in which legs depend from the appliance and support the appliance above and on a support surface, and the other being a storage position in which the legs fold into a more compact configuration and simultaneously retain the lid to the appliance.

### FIELD OF THE INVENTION

The present invention relates to cooking appliances. In particular, the present disclosure is directed to a cooking appliance such as a skillet, griddle and the like, having a removable lid and feet which extend there-under to support the appliance on and above a support surface.

### BACKGROUND OF THE INVENTION

A large number of household electric kitchen appliances are available and in use in modern household kitchens. The number of electrical appliances has increased to the point that available kitchen counter and storage space is at a premium. While attractive as specialty cooking appliances griddles and skillets are generally large and require more counter space than is practicable to keep them on the kitchen counter when not in use. As a result, cooking appliances suited for storage in a minimal footprint are attractive to buyers. In particular, it is highly desirable for such an appliance to be capable of vertical storage with its lid so as to reduce overall storage space required.

### SUMMARY OF THE INVENTION

The statements of this section merely provide background information related to the present disclosure and may not constitute prior art.

The present disclosure is directed to a cooking appliance, such as, but not limited to, a skillet or griddle, having a folding leg system. More specifically, the present disclosure is directed to a cooking appliance having a removable lid and having legs which are foldable into at least two positions, a first operable position in which the legs depend from and support the appliance on and above a support surface, and a second storage position in which the legs fold into a more compact configuration and simultaneously retain the removable lid in a fixed relationship with the appliance.

### BRIEF DESCRIPTION OF THE DRAWINGS

The organization and manner of the structure and function of the present invention, together with further aspects and advantages thereof, may be understood by reference to the following description taken in connection with the accompanying drawings, wherein like reference numerals identify like elements, corresponding part and/or features and in which:

FIG. 1 shows a partially exploded perspective view of a lidded cooking appliance according to a preferred embodiment of the invention showing the legs extended into their operable position;

FIG. 2 shows a side view of the appliance of FIG. 1 with the legs in their operable position;

FIG. 3 shows an end view of the appliance of FIG. 1 with the legs in their operable position;

FIG. 4 shows a perspective view of the appliance of FIG. 1 with the lid inverted and positioned partially within the cooking appliance and with the legs folded into their compact storage position which simultaneously retains the lid in a fixed position relative to the appliance;

FIG. 5 shows a side view of the appliance of FIG. 1 with the appliance in its storage configuration; and

FIG. 6 shows an end view of the appliance of FIG. 1 with the appliance in its storage configuration.

### DETAILED DESCRIPTION OF THE PREFERRED EMBODIMENT

While the present invention may be susceptible to embodiment in different forms, there are shown in the drawings, and herein will be described in detail, embodiments with the understanding that the present description is to be considered an exemplification of the principles of the invention and is not intended to limit the invention to that as illustrated and described herein. Instead, it is envisioned that those skilled in the art may devise various modifications and equivalents without departing from the spirit and scope of the appended claims.

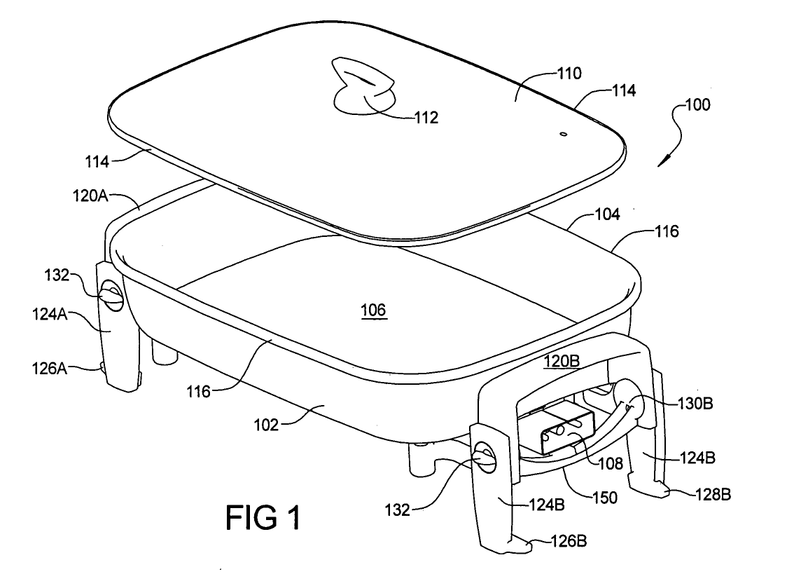

Referring now to FIG. 1, skillet 100 includes a shallow-well cooking body 102 having a generally vertical peripheral side wall 104 surrounding an electrically heated bottom cooking surface 106. The cooking surface 106 is adapted to receive and heat food for cooking. The cooking body 102 is preferably made of die-cast aluminum with a resistance heating element embedded within the bottom cooking surface 106. The heating element is connectable to an AC power supply through electrical connector 108, which is adapted to receive a power cord (not shown), such as a thermostatically-controlled power supply cord.

Lid 110 is adapted to fit over and cover cooking body 102. As best seen in FIG. 1, during operation of skillet 100, the lid 110 is oriented such that grasp knob 112 is directed away from the cooking body 102. Lid 110 is further adapted to fit over and partially within the cooking body 102 during its storage configuration. In such configuration, lid 110 is oriented such that grasping knob 112 is directed toward cooking body 102. Peripheral edge 114 of lid 110 is shaped and configured to fit on and within the upper peripheral rim 116 of the cooking body's upstanding peripheral side wall 104, both during the lid's operable and storage positions.

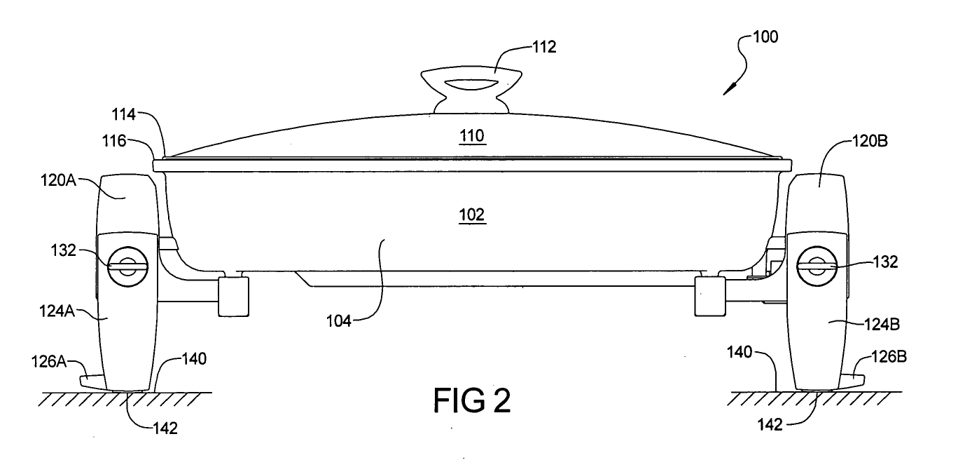

As seen in FIG. 2, handles 120A and 120B are affixed at opposing ends of cooking body 102, and are adapted for use in the transport of the skillet 100 in both the operable or storage configuration. Handles 120A and 120B are spaced apart from upper peripheral rim 116 to allow for removal and replacement of lid 110 without interference.

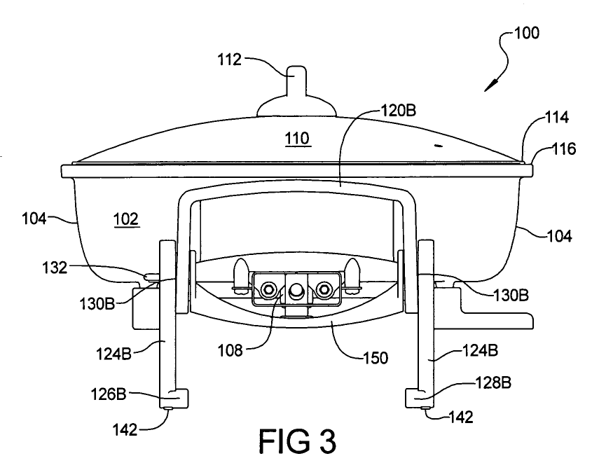

Leg pair 124A, seen in more detail in FIGS. 1-3, which include feet 126A and 128A, are pivotally affixed to handle 120A at hinge 130A and movable relative to the handle 120A and cooking body 102 between at least two functional positions. The first such position, indicated as the operable position, includes leg pair 124A depending from and supporting cooking body 102 on and above a support surface. The second such position, indicated as the storage position, includes leg pair 124A folded into a compact position which additionally serves to further retain the lid 110 of skillet 100 in a fixed and secured relationship with cooking body 102.

Likewise, leg pair 124B, seen in more detail in FIGS. 1-3, which include feet 126B and 128B, are pivotally affixed to handle 120B at hinge 130B and movable relative to the handle 120B and cooking body 102 between at least two functional positions, including the operable position in which leg pair 124B depends from and supports cooking body 102 on and above a support surface, and the storage position in which leg pair 124B is folded into a compact position which additionally serves to retain the lid 110 of skillet 100 in a fixed and secured relationship with cooking body 102.

Release mechanisms 132 are disposed within the pivotable connections of hinges 130A and 130B to handles 120A and 120B, respectively. The release mechanisms 132 are adapted to allow free relative pivotal movement between the handles 120A and 120B and leg pairs 124A and 124B about the hinges 130A and 130B. The disposition of release mechanisms 132 at the end of hinges 130 is optimal for allowing a user to activate the release mechanisms 132 while simultaneously pivoting the leg pairs 124 from one position to another.

When leg pairs 124 are pivoted downward into their operable position, feet 126 and 128 lie on a common plane that is parallel to and spaced apart from the underside of bottom cooking surface 106. When the leg pairs 124A and 124B are rotated to the operable position, the release mechanisms 132 rigidly lock the legs into this supportive configuration. The release mechanisms 132 generate an audible “popping” or “clicking” noise which serve to notify a user that the leg pairs 124 are firmly locked into their operable position. While in this operable position, feet 126 and 128 are rested on a support surface 140 and are thereby adapted to support the cooking body 106 above and apart from the support surface 140 to avoid excessive heat transfer to the support surface 140. Rubber pads 142 are included on the underside of the feet 126 and 128 to prevent inadvertent slippage of the skillet 100 during use. It should be noted that any material sufficient to prevent such slippage may be interchangeably used in the place of the rubber feet.

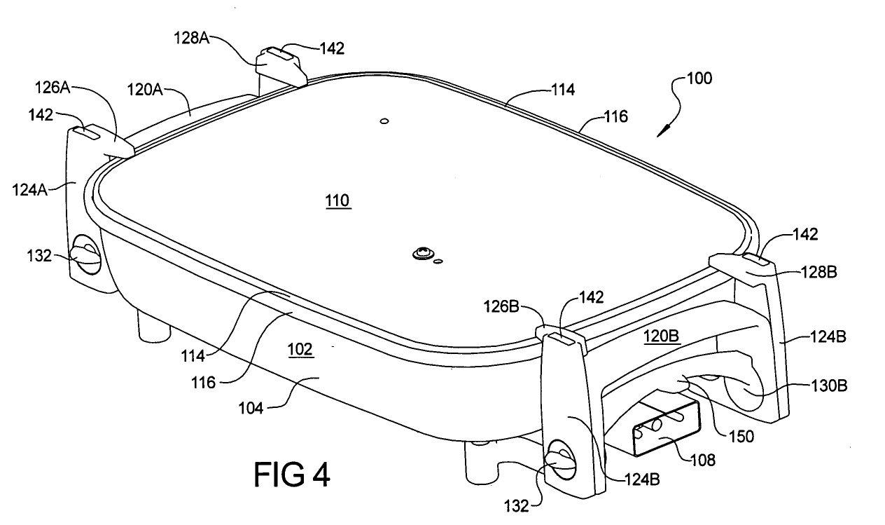

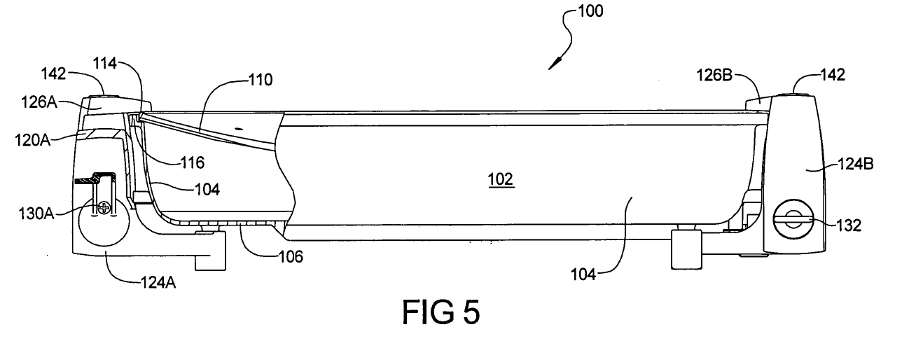

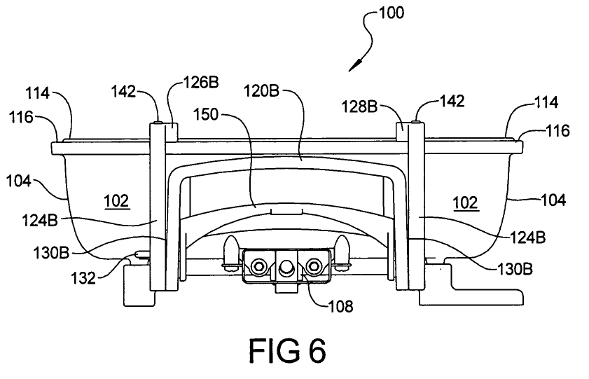

When not in use, skillet 100 may be configured into a compact storage configuration as shown in FIGS. 4-6. In such configuration, lid 110 is first inverted and placed partially within cooking body 106 as shown. As can be appreciated from the drawings, the lid 110 occupies less volume outside of the appliance in this configuration.

Release mechanisms 132 are operated to free leg pairs 124A and 124B so they may be pivoted upward into their storage positions. The upper side of feet 126 and 128, now inverted, capture lid 110 along a portion of its periphery and hold it in position, partially within cooking body 106. As with the rotation of the leg pairs 124 into their operable position, when the leg pairs 124 are rotated into their storage position release mechanisms 132 generate an audible “popping” or “clicking” noise which serve to notify a user that the leg pairs 124 are firmly locked into their storage position.

The feet 126 and 128 now press against lid 110 and serve as a shock absorber to retain the lid 110 firmly and quietly in its stored position. Additionally, the feet 126 and 128 prevent rattling and damage to the lid 110 during transport or storage of the skillet 100. In this storage configuration, the skillet 100 may be stored in a vertical position thus occupying less space.

Finally, a bar 150 is disposed between leg pair 124B and rotatable on hinge 130B. As best seen in FIG. 1, bar 150 exposes connector 108 when leg pair 124B is fully pivoted into its operable position or when it is fully pivoted into its storage position. Such operation, while allowing access to the connector 108 for the receipt of the removable power cord (not shown), prevents a user from energizing the heating elements within bottom cooking surface 106 during the conversion process from one configuration to the other. This is because leg pair 124B cannot be raised into its storage position or lowered into its operable position unless and until the power cord has been removed from connector 108, as the power cord would interfere with the rotation of hinge 130B. Alternatively, an equivalent to bar 150 may be disposed elsewhere on leg pair 124B to allow access to connector 108 only when the leg pair 124B is in its operable position.

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification and the following claims.

1. A cooking appliance, comprising:
a cooking body adapted to receive and cook a food item;
a removable lid for covering the cooking body;
a support and retention member adaptable into at least a first position wherein the support member supports the cooking body above a support surface, and a second position wherein the support member retains the lid to said cooking body to prevent removal therefrom.

2. The cooking appliance of claim 1, wherein the support and retention member is a pair of support legs jointly pivotable about a hinge from the first position to the second position.

3. The cooking appliance of claim 2, wherein the cooking appliance is further adapted to cook a food item by electrical energy supplied through a power source that is removably connected to the cooking body; and wherein a bar between the pair of support legs and pivotable about the hinge is adapted to allow access to an electrical connection for the removable power source when the pair of support legs is in the first position.

4. The cooking appliance of claim 3, wherein the hinge is configured for selectively locking the pair of support legs such that they are not pivotable and are fixed when fully extended into either the first or second position.

5. The cooking appliance of claim 2, wherein each of the first pair of support legs comprises feet portions configured to rest on the support surface when in the first position and to engage and retain the lid to the cooking body when in the second position.

6. The cooking appliance of claim 5, wherein each of the feet portions includes a slip-resistant pad attached to the underside of the feet portion when in the first position and facing upward when in the second position.

7. The cooking appliance of claim 6 wherein the slip-resistant material is rubber.

8. A cooking appliance comprising:
a cooking body adapted to receive and cook a food item;
a removable lid for covering the cooking body;
a pair of fixed handles located at opposite ends of the cooking body and space apart from the cooking body;
a first pair of support legs positioned at a first end of the cooking body and adaptable into at least a first position for supporting the cooking body above a support surface, and a second position for retaining the lid to the cooking body to prevent removal therefrom; and
a second pair of support legs positioned at a second end of the cooking body opposite the first end of the cooking body and adaptable into at least a first position for supporting the cooking body above a support surface, and a second position for retaining the lid to the cooking body to prevent removal therefrom.

9. The cooking appliance of claim 8, wherein the first and second pairs of support legs are individually pivotable about respective associated hinges from the first position to the second position.

10. The cooking appliance of claim 9, wherein the cooking appliance is further adapted to cook a food item by electrical energy supplied through a power source that is removably connected to the cooking body;
wherein a bar is provided between the first pair of support legs and is pivotable about the hinge associated with the first pair of support legs; and
wherein the bar is adapted to allow access to an electrical connection for the removable power source only when the first pair of support legs is in the first position or the second position.

11. The cooking appliance of claim 9, wherein each of the hinges associate with one of the first and second pairs of support legs is configured for selectively locking its associated pair of support legs such that they are not pivotable and are fixed when fully extended into either the first or second position.

12. The electrical cooking appliance of claim 11, wherein the removable lid is configured to rest on and within the peripheral rim of the cooking body in both the operative and storage configurations.

13. A cooking appliance comprising:
a shallow-well cooking body adapted for receiving and retaining food items during cooking;
a removable lid for covering the cooking body;
an electrical heating element internal to the bottom of the cooking body;
a first pair of support legs positioned at a first end of the cooking body and adaptable into at least a first position for supporting the cooking body above a support surface, and a second position for retaining the lid to the cooking body to prevent removal therefrom; and
a second pair of support legs positioned at a second end of the cooking body opposite the first end of the cooking body and adaptable into at least a first position for supporting the cooking body above a support surface, and a second position for retaining the lid to the cooking body to prevent removal therefrom.

14. The cooking appliance of claim 13, wherein the removable lid is configured to rest on and within the peripheral rim of the cooking body in both an operative and storage configuration.

15. The cooking appliance of claim 14, wherein the removable lid is secured in an inverted position within the cooking body in the storage configuration by the first and second pairs of support legs.

16. The cooking appliance of claim 13, wherein the electrical heating element includes a receptacle for receipt of a removable power source connection.

17. The cooking appliance of claim 16, further comprising a safety bar provided between the first pair of support legs and pivotable about a hinge associated with the first pair of support legs, wherein the safety bar is adapted to allow access to the receptacle only when the first pair of support legs is in the first position or the second position.
